(19) United States
(12) Patent Application Publication
(10) Pub. No.: US 2016/0256884 A1
(43) Pub. Date: Sep. 8, 2016

(54) Painting Jig Assembly

(71) Applicant: Jose Calles, Belvidere, IL (US)

(72) Inventor: Jose Calles, Belvidere, IL (US)

(21) Appl. No.: 14/640,256

(22) Filed: Mar. 6, 2015

(51) Int. Cl. B05B 13/02

(52) U.S. Cl. CPC B05B 13/0221

(57) ABSTRACT

A painting jig assembly includes a frame that may be positioned on a support surface. A mount is attached to the frame and the mount may have a door mounted therein such that the door is retained in an upright position thereby facilitating all sides of the door to be painted.

### BACKGROUND OF THE DISCLOSURE

### Field of the Disclosure

The disclosure relates to jig devices and more particularly pertains to a new jig device for positioning a door to be painted.

### SUMMARY OF THE DISCLOSURE

An embodiment of the disclosure meets the needs presented above by generally comprising a frame that may be positioned on a support surface. A mount is attached to the frame and the mount may have a door mounted therein such that the door is retained in an upright position thereby facilitating all sides of the door to be painted.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a painting jig assembly according to an embodiment of the disclosure.

FIG. 2 is a front view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

FIG. 6 is a front in-use view of an embodiment of the disclosure.

### DESCRIPTION OF THE PREFERRED EMBODIMENT

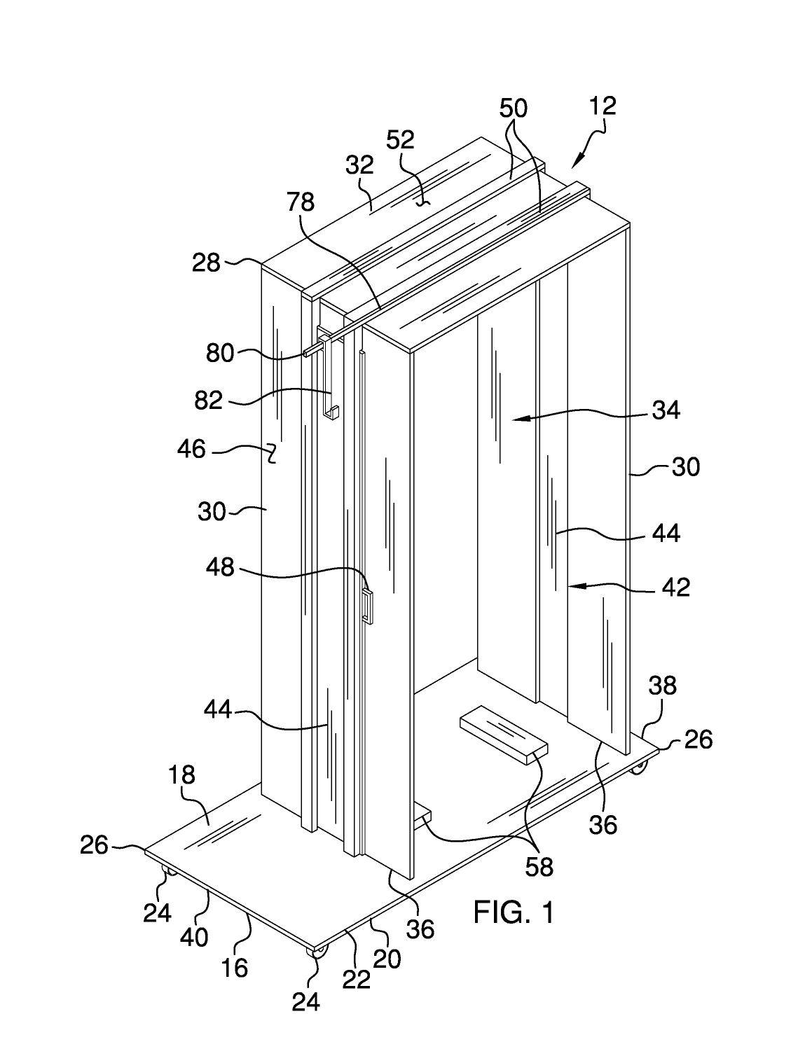

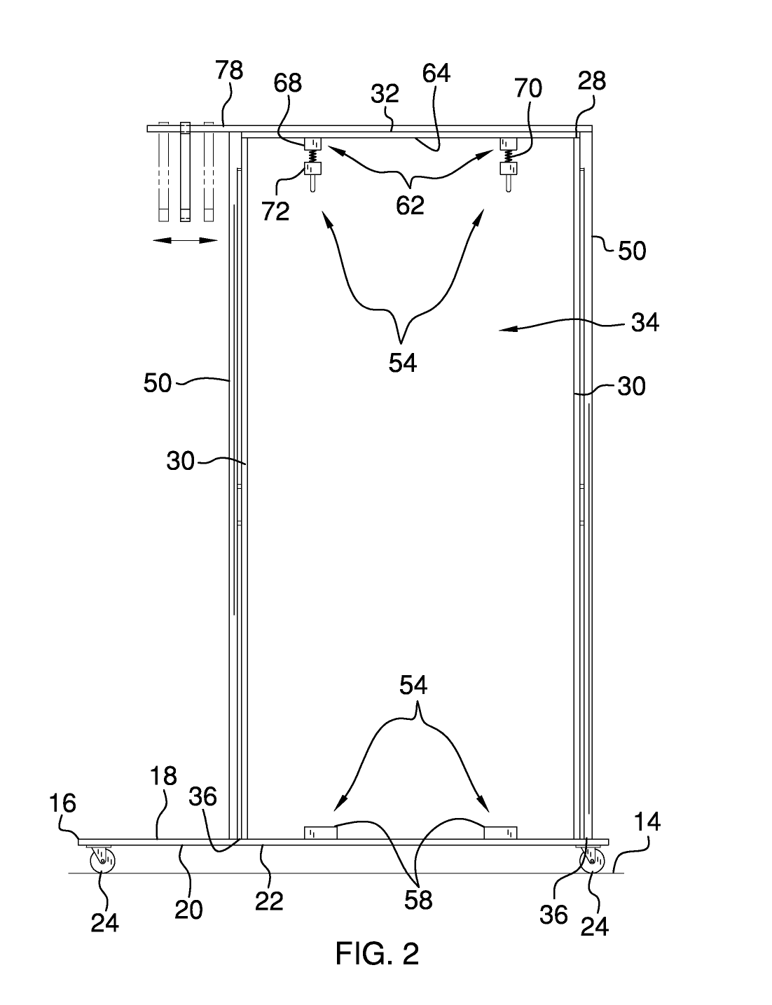

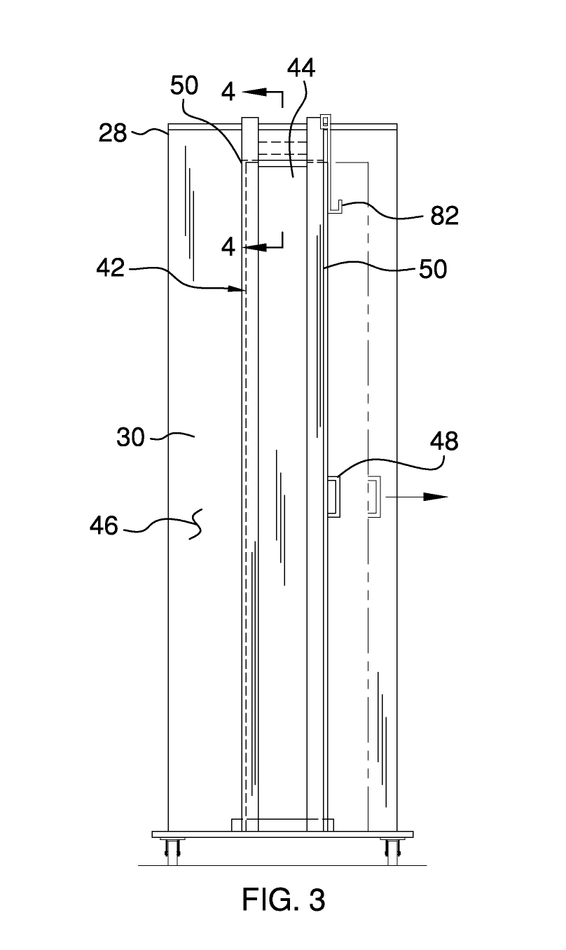

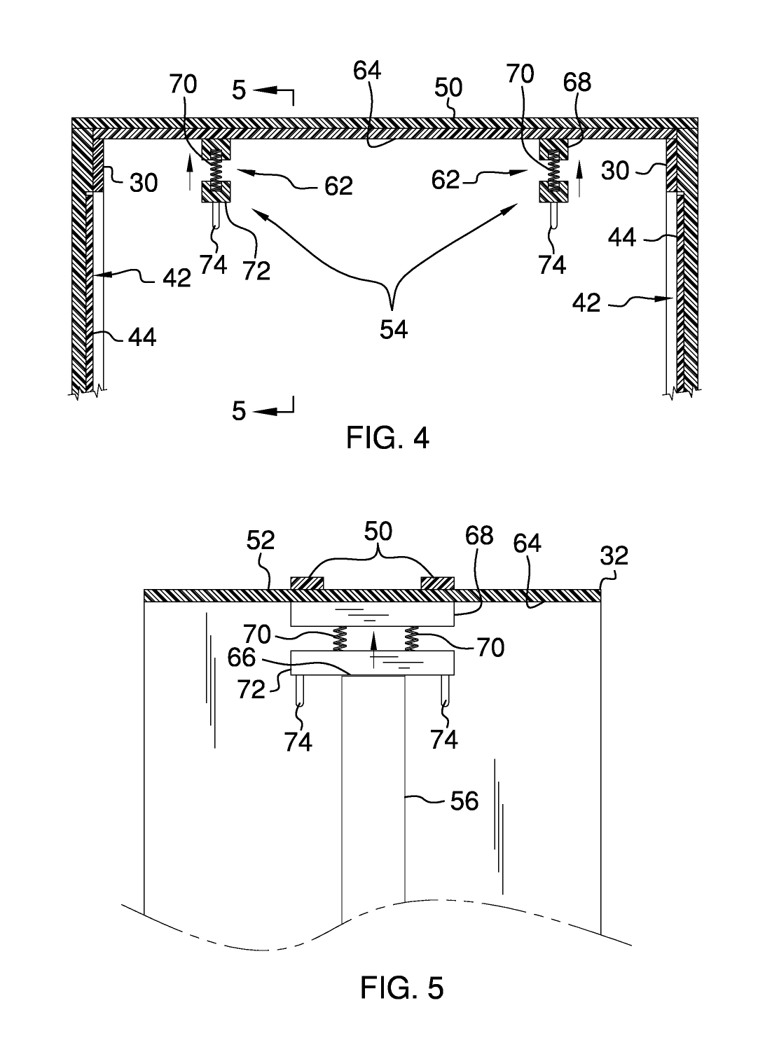

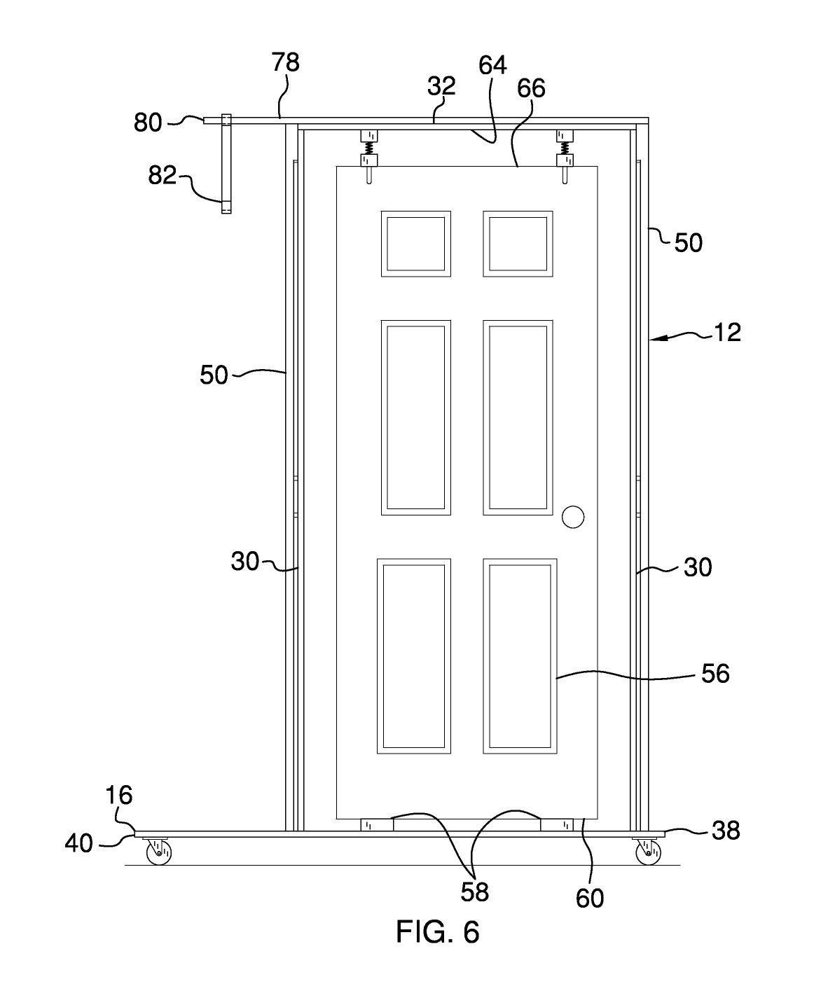

With reference now to the drawings, and in particular to FIGS. 1 through 6 thereof, a new jig device embodying the principles and concepts of an embodiment of the disclosure and generally designated by the reference numeral 10 will be described.

As best illustrated in FIGS. 1 through 6, the painting jig assembly 10 generally comprises a frame 12 that may be positioned on a support surface 14 and the support surface 14 may be a floor or the like. The frame 12 comprises a base 16 that has a top side 18, a bottom side 20 and a peripheral edge 22 extending between the top side 18 and the bottom side 20. A plurality of wheels 24 is movably coupled to the bottom side 20 and each of the wheels 24 is positioned adjacent to one of four corners 26 of the base 16. The wheels 24 may roll along the support surface 14.

The frame 12 further comprises an upright 28 that has a pair of legs 30 attached to and extending downwardly from a central member 32. The legs 30 are spaced apart from each other to define a door space 34 between the legs 30 and each of the legs 30 has a distal end 36 with respect to the central member 32. The distal end 36 of each of the legs 30 is attached to the top side 18 of the base 16 and the peripheral edge 33 of the base 16 has a first lateral side 38 and a second lateral side 40. The upright 28 is positioned closer to the first lateral side 38 than the second lateral side 40 and each of the legs 30 has an opening 42 extending therethrough. The opening 42 extends substantially between the central member 32 and the distal end 36. The upright 28 may have a height ranging between approximately 7 feet and 8 feet and a width ranging between approximately 4 feet and 5 feet.

A pair of covers 44 is provided and each of the covers 44 is slidably attached to the upright 28. Each of the legs 30 has an outwardly facing surface 46 and one of the covers 44 is positioned on the outwardly facing surface 46 of one of the legs 30. One of the covers 44 is positioned on the outwardly facing surface 46 of one of the legs 30 and each of the covers 44 is slidable into an open position to expose the opening 42. Each of the covers 44 is slidable into a closed position to cover the opening 42. A pair of grips 48 is provided and each of the grips 48 is attached to one of the covers 44. Each of the grips 48 may be gripped to position the covers 44 between the open position and the closed position.

A pair of restraints 50 is provided and each of the restraints 50 is attached to the upright 28. The central member 32 has an upper surface 52 and each of the restraints 50 extends along the outwardly facing surface 46 of each of the legs 30 and the upper surface 52 of the central member 32. Each of the restraints 50 is spaced apart from each other and each of the restraints 50 frames the opening 42 in each of the legs 30. Each of the restraints 50 retains the covers 44 on the upright 28.

A mount 54 is attached to the frame 12 and the mount 54 may have a door 56 mounted therein such that the door 56 is retained in an upright position thereby facilitating all sides of the door 56 to be painted. The door 56 may be an interior door or an exterior door of a building. The mount 54 comprises a pair of blocks 58 and each of the blocks 58 is attached to the top side 18 of the base 16. Each of the blocks 58 is positioned between the pair of legs 30 and the blocks 58 are spaced apart from each other. Each of the blocks 58 may have a lower edge 60 of the door 56 positioned thereon such that the door 56 is positioned within the door space 34.

A pair of grips 62 is provided and the central member 32 has a lower side 64.

Each of the grips 62 is attached to and extends downwardly from the lower side 64 and each of the grips 62 is aligned with one of the blocks 58. Each of the grips 62 releasably engages a top edge 66 of the door 56 such that the door 56 is retained within the upright 28. Each of the grips 62 comprises a first plate 68 that is attached to the lower side 64 and the grips 62 include pair of spring biasing members 70. Each of the spring biasing members 70 is attached to and extends downwardly from the first plate 68 and a second plate 72 is attached to each of the spring biasing members 70. The second plate 72 is spaced from the first plate 68.

A pair of pins 74 is each attached to and extends downwardly from the second plate 72. The pins 74 are spaced apart from each other and the second plate 72 abuts the top edge 66 of the door 56 such that the door 56 is positioned between the pins 74. The pins 74 prevent the door 56 from sliding forwardly or rearwardly off of the second plate 72. Moreover, each of the covers 44 provides access to each lateral edge 76 of the door 56 when the door 56 is positioned within the mount 54 thereby facilitating the lateral edges 76 of the door 56 to be painted. A rod 78 is attached to the upper surface 52 of the central member 32 and the rod 78 extends beyond one of the legs 30 of the upright 28. The rod 78 has a first end 80 and a hook 82 is attached to the first end 82. The hook 82 may have an object suspended thereon while the door 56 is being painted.

In use, the lower edge 60 of the door 56 is positioned on the pair of blocks 58 and the top edge 66 of the door 56 is positioned within each of the pair of grips 62. The door 56 is painted while the door 56 is positioned within the frame 12. Each of the covers 44 is positioned in the open position and each of the lateral edges 76 of the door 56 are painted. The upright 28 retains the door 56 in a convenient orientation for painting and the upright 28 inhibits overspray from painting of the door 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A painting jig assembly configured to retain a door thereby facilitating the door to be painted, said assembly comprising:
a frame configured to be positioned on a support surface; and
a mount attached to said frame, said mount being configured have a door mounted therein such that the door is retained in an upright position thereby facilitating all sides of the door to be painted.

2. The assembly according to claim 1, wherein said frame comprises a base having a top side, a bottom side and a peripheral edge extending between said top side and said bottom side, a plurality of wheels movably coupled to said bottom side, each of said wheels being positioned adjacent to one of four corners of said base, said wheels being configured to roll along the support surface.

3. The assembly according to claim 2, wherein said frame further comprises an upright having a pair of legs attached to and extending downwardly from a central member, said legs being spaced apart from each other to define a door space between said legs, each of said legs having a distal end with respect to said central member, said distal end of each of said legs being attached to said top side of said base, said peripheral edge of said base having a first lateral side and a second lateral side, said upright being positioned closer to said first lateral side than said second lateral side, each of said legs having an opening extending therethrough, said opening extending substantially between said central member and said distal end.

4. The assembly according to claim 3, further comprising a pair of covers, each of said covers being slidably attached to said upright, each of said legs having an outwardly facing surface, one of said covers being positioned on said outwardly facing surface of one of said legs, one of said covers being positioned on said outwardly facing surface of one of said legs, each of said covers being slidable into an open position to expose said opening, each of said covers being slidable into a closed position to cover said opening.

5. The assembly according to claim 4, further comprising a pair of restraints, each of said restraints being attached to said upright, said central member having an upper surface, each of said restraints extending along said outwardly facing surface of each of said legs and said upper surface of said central member, each of said restraints being spaced apart from each other, each of said restraints framing said opening in each of said legs, each of said restraints retaining said covers on said upright.

6. The assembly according to claim 1, wherein:
said frame includes a base, a pair of legs and a door space, said base having a top side; and
said mount comprises a pair of blocks, each of said blocks being attached to said top side of said base, each of said blocks being positioned between said pair of legs, said blocks being spaced apart from each other, each of said blocks being configured to have a lower edge of the door positioned thereon such that the door is positioned within said door space.

7. The assembly according to claim 6, wherein:
said frame includes an upright, said upright including a central member; and
said mount further comprises a pair of grips, said central member having a lower side, each of said grips being attached to and extending downwardly from said lower side, each of said grips being aligned with one of said blocks, each of said grips being configured to releasably engage a top edge of the door such that the door is retained within said upright.

8. The assembly according to claim 7, wherein each of said grips comprises a first plate being attached to said lower side, a pair of spring biasing members, each of said spring biasing members being attached to and extending downwardly from said first plate, a second plate attached to each of said spring biasing members, said second plate being spaced from said first plate.

9. The assembly according to claim 8, further comprising:
a pair of covers; and
a pair of pins, each of said pins being attached to and extending downwardly from said second plate, said pins being spaced apart from each other, said second plate being configured to abut the top edge of the door such that the door is positioned between said pins, said pins preventing the door from sliding forwardly or rearwardly off of said second plate, each of said covers being configured to provide access to each lateral edge of the door when the door is positioned within said mount thereby facilitating the lateral edges to be painted.

10. A painting jig assembly configured to retain a door thereby facilitating the door to be painted, said assembly comprising:
a frame configured to be positioned on a support surface, said frame comprising
a base having a top side, a bottom side and a peripheral edge extending between said top side and said bottom side,
a plurality of wheels movably coupled to said bottom side, each of said wheels being positioned adjacent to one of four corners of said base, said wheels being configured to roll along the support surface, and
an upright having a pair of legs attached to and extending downwardly from a central member, said legs being spaced apart from each other to define a door space between said legs, each of said legs having a distal end with respect to said central member, said distal end of each of said legs being attached to said top side of said base, said peripheral edge of said base having a first lateral side and a second lateral side, said upright being positioned closer to said first lateral side than said second lateral side, each of said legs having an opening extending therethrough, said opening extending substantially between said central member and said distal end,
a pair of covers, each of said covers being slidably attached to said upright, each of said legs having an outwardly facing surface, one of said covers being positioned on said outwardly facing surface of one of said legs, one of said covers being positioned on said outwardly facing surface of one of said legs, each of said covers being slidable into an open position to expose said opening, each of said covers being slidable into a closed position to cover said opening, and
a pair of restraints, each of said restraints being attached to said upright, said central member having an upper surface, each of said restraints extending along said outwardly facing surface of each of said legs and said upper surface of said central member, each of said restraints being spaced apart from each other, each of said restraints framing said opening in each of said legs, each of said restraints retaining said covers on said upright, and
a mount attached to said frame, said mount being configured have a door mounted therein such that the door is retained in an upright position thereby facilitating all sides of the door to be painted, said mount comprising
a pair of blocks, each of said blocks being attached to said top side of said base, each of said blocks being positioned between said pair of legs, said blocks being spaced apart from each other, each of said blocks being configured to have a lower edge of the door positioned thereon such that the door is positioned within said door space,
a pair of grips, said central member having a lower side, each of said grips being attached to and extending downwardly from said lower side, each of said grips being aligned with one of said blocks, each of said grips being configured to releasably engage a top edge of the door such that the door is retained within said upright, each of said grips comprising
a first plate being attached to said lower side,
a pair of spring biasing members, each of said spring biasing members being attached to and extending downwardly from said first plate,
a second plate attached to each of said spring biasing members, said second plate being spaced from said first plate, and
a pair of pins, each of said pins being attached to and extending downwardly from said second plate, said pins being spaced apart from each other, said second plate being configured to abut the top edge of the door such that the door is positioned between said pins, said pins preventing the door from sliding forwardly or rearwardly off of said second plate, each of said covers being configured to provide access to each lateral edge of the door when the door is positioned within said mount thereby facilitating the lateral edges to be painted.
